(19) United States
(12) Patent Application Publication
(10) Pub. No.: US 2021/0326236 A1
(43) Pub. Date: Oct. 21, 2021

(54) SYSTEMS AND METHODS FOR RESILIENCY TESTING

(71) Applicant: JPMorgan Chase Bank, N.A., New York, NY (US)

(72) Inventors: Brian Jeffrey MONTEITH, Naperville, IL (US); Michael Robert LYONS, Geneva, IL (US); Robert MATLES, Glenview, IL (US)

(21) Appl. No.: 15/056,091

(22) Filed: Feb. 29, 2016

(51) Int. Cl. G06F 11/36

(52) U.S. Cl. CPC G06F 11/3608

(57) ABSTRACT

Systems and methods for resiliency testing are disclosed. In one embodiment, a method for building rules based on application execution information may include (1) an agent deploying to a software application; (2) the agent receiving an application behavior rule; (3) the agent monitoring execution of the software application; (4) the agent detecting a breach of the application behavior rule during software application; (5) the agent retrieving application execution information from the software application; and (6) the agent outputting the application execution information.

### BACKGROUND OF THE INVENTION

### 1. Field of the Invention

The present invention generally relates to systems and methods for resiliency testing.

### 2. Description of the Related Art

Software resilience is the ability of software (e.g., an application, a program, etc.) to react to problems in one of its components or an external system and still provide the best possible service. Resiliency has become more important as organizations continue to rapidly implement software across multi-tier, multiple technology infrastructures. Most software is tested for resiliency —to determine how stable the software is—before it is deployed.

### SUMMARY OF THE INVENTION

Systems and methods for resiliency testing are disclosed. In one embodiment, a method for building rules based on application execution information may include (1) an agent deploying to a software application; (2) the agent receiving an application behavior rule; (3) the agent monitoring execution of the software application; (4) the agent detecting a breach of the application behavior rule during software application; (5) the agent retrieving application execution information from the software application; and (6) the agent outputting the application execution information.

In one embodiment, the method may further include the agent receiving a modification to the application behavior rule, a deletion of the application behavior rule, a change to the application behavior rule, the enablement or disablement of the application behavior rule, etc.

In one embodiment, the agent may receive the application behavior rule from a control server.

In one embodiment, the agent may be deployed during initiation of the software application.

According to another embodiment, a method for resiliency testing may include (1) identifying a fault to simulate in a software application; (2) selecting a fault-simulating component to simulate the fault; (3) executing the software application with the fault-simulating component; and (4) at least one computer processor identifying a resiliency problem based on the fault-simulating component.

In one embodiment, the fault may be based on slowness, an outage, a hardware failure, a lack of responsiveness, etc.

In one embodiment, the method may further include creating an information gathering component to collect execution data related to the resiliency problem; deploying the information-gathering component to the software; executing the software application with the fault-simulating component and the information-gathering component; collecting execution data using the information-gathering component; and outputting the collected execution data.

In one embodiment, the information gathering component may comprise a software component that may be injected into the into the software application.

In one embodiment, the execution data may comprise runtime data.

In one embodiment, the method may further include selecting a solution component for the resiliency problem; deploying the information-gathering component to the software; executing the software with the fault-simulating component and the solution component; and determining that the resiliency problem based on the fault-simulating component is not present.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for resiliency testing according to one embodiment.

FIG. 2 depicts an exemplary depiction of a rule being applied to an application according to one embodiment.

FIG. 3 depicts an exemplary depiction of a rule being applied to an application according to one embodiment.

FIG. 4 depicts an exemplary method that for building rules based on application execution information according to one embodiment.

FIG. 5 depicts an exemplary graphical user interface according to one embodiment.

FIG. 6 depicts a method for setting application behavior rules according to one embodiment.

FIGS. 7 and 8 depict a method for resiliency testing according to one embodiment.

### DETAILED DESCRIPTION OF PREFERRED EMBODIMENTS

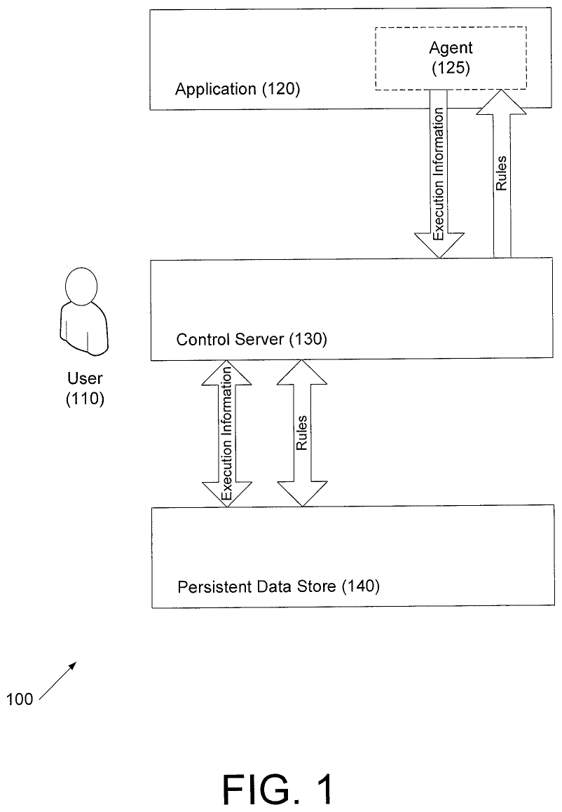

Several embodiments of the present invention and their advantages may be understood by referring to FIGS. 1-8.

Embodiments disclosed herein are generally directed to improving application fault tolerance via the simulation of real-world faults/failures in test. For example, embodiments disclosed herein are directed to a framework, application, utility, etc. that simulates faults/failures within a system, which may include an application, the hardware and/or network that the application runs on, and any application(s) that the application may communicate with to assist in the development of more fault-tolerant systems. Examples of faults/failures include slowness, data corruption, and hardware failures.

In one embodiment, a software based application framework may be used to enable real, effective High Availability (“HA”) testing for applications. It may operate transparently within the application, thereby eliminating dependencies on external partners and/or systems, eliminating need for cross-domain technical expertise and access, reducing cost and effort of implementation, and improving test quality and coverage.

In one embodiment, the software-based application may be any application that is agnostic to the application language, such as .NET, Cobol, Java, etc.).

Embodiments may seamlessly inject executable instructions at runtime to simulate desired behaviors (e.g., faults and/or failures) without compromising or modifying application business logic and without requiring any changes to current code or deployment.

Embodiments may seamlessly inject executable instructions into a deployment before execution to simulate desired behaviors without compromising or modifying application business logic.

Embodiments may not only simulate behaviors and scenarios, but may also identify risk and contain issues. For example, embodiments may simulate fraud.

Embodiments disclosed herein may simulate faults and/or failures such as network failures, server and system outages, unresponsive processes, data corruption, queue failures/capacity issues, slow responses, internal and external errors, or any other condition to simulate as is necessary and/or desired.

Embodiments may further provide insight into the operation of an application, for example, in response to a simulated fault/failure condition.

Embodiments may further prototype and/or simulate proof of concepts of various types of solutions to problems to determine whether or not those solutions will be effective before they are actually built. For example, if an external system becomes slow, and an application that interacts with the external system is waiting for it, gates may be deployed that only a portion of the application wait for that external system, while the rest of the application operates normally.

Referring to FIG. 1, a system for resiliency testing according to one embodiment is disclosed. System 100 may include application 120, control server 130, and persistent data store 140. In one embodiment, application 120 may be any application, program, etc. that may be executed by a computer processor (not shown). In one embodiment, application 120 may be a web-based application. In another embodiment, application 120 may be a program executed on a workstation. In another embodiment, application 120 may be an application executed by a mobile device. In another embodiment, application 120 may be a cloud-based application. In still another embodiment, application 120 may be part of an embedded system.

Application 120 may be provided with agent 125. In one embodiment, agent 125 may interface with control server 130 and may be provided with rules for applying behaviors that may simulate faults/failures. For example, agent 125 may be provided with a rule that activates a behavior that simulates a runtime fault/failure. Other rules may be provided as necessary and/or desired.

In one embodiment, agent 125 may be provided with rules to expose runtime data to gain insight into application state, such as logging or metrics to a monitoring tool. It may also be provided with rules to apply error handling or recovery instructions to better handle a runtime fault, such as a proof-of-concept test for a potential solution.

Agent 125 may provide control server 130 with execution information for application 120. For example, agent 125 may provide runtime data, unit names, and software information. Other information may be provided as is necessary and/or desired.

In one embodiment, agent 125 may be a Java agent. In another embodiment, agent 125 may be part of the application's process. In another embodiment, agent 125 may be part of an application deployment file. In another embodiment, agent 125 may be loaded in the application server, and may identify a suitable application to associate with.

In general, the behaviors that may be introduced to simulate faults/failures may be added by rewriting the executable instructions for application 120 when application 120 is loaded, by modifying the executable instruction files for application 120 before they are loaded, or by creating a substitute component after application 120 is loaded.

Control server 130 may communicate with persistent data store 140, which may store a library of rules for applying behaviors for selection by user 110. Persistent data store 140 may also store custom rules developed by user 110.

Control server 130 may provide persistent data store 140 with execution information from agent 125. In one embodiment, control server 130 may further retrieve stored execution information from persistent data store 140.

In one embodiment, control server 130 may comprise any suitable device, including servers, workstations, desktop computers, notebook computers, tablet computers, smart phones, etc.

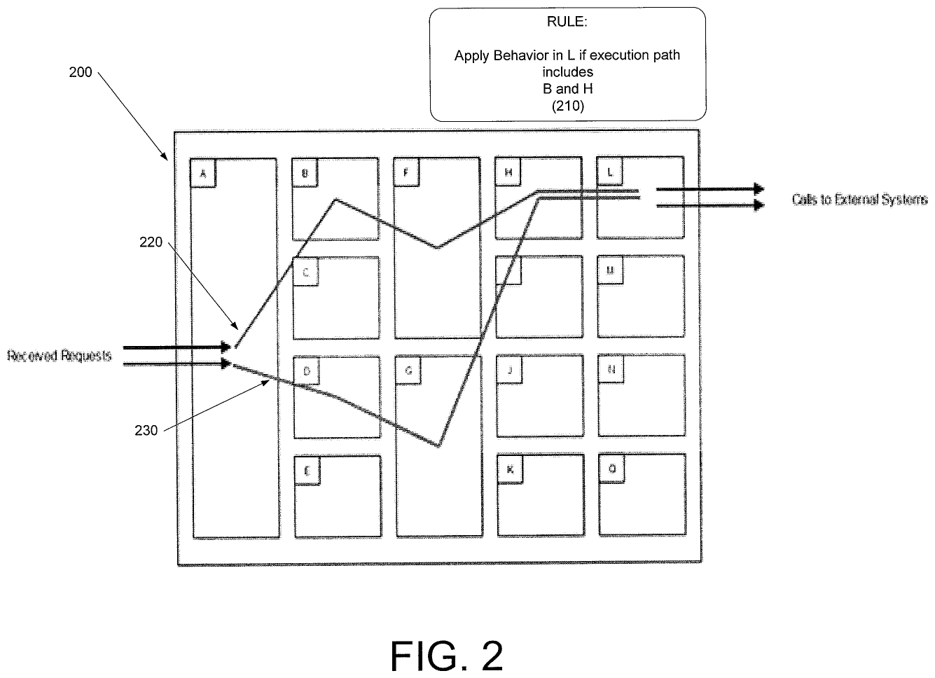

Referring to FIG. 2, an exemplary depiction of a rule being applied to application 200 consisting of logical subsections A-O (e.g., layers, libraries, classes, etc.) based on the code execution path is illustrated. In one embodiment, rule 210, “apply behavior in L if path includes B and H,” is applied by the agent. As illustrated execution path 220 includes both logical subsection, thereby meeting rule 210, while execution path 230 does not. When the rule is met, the agent may activate behavior L, such as simulating a fault/failure.

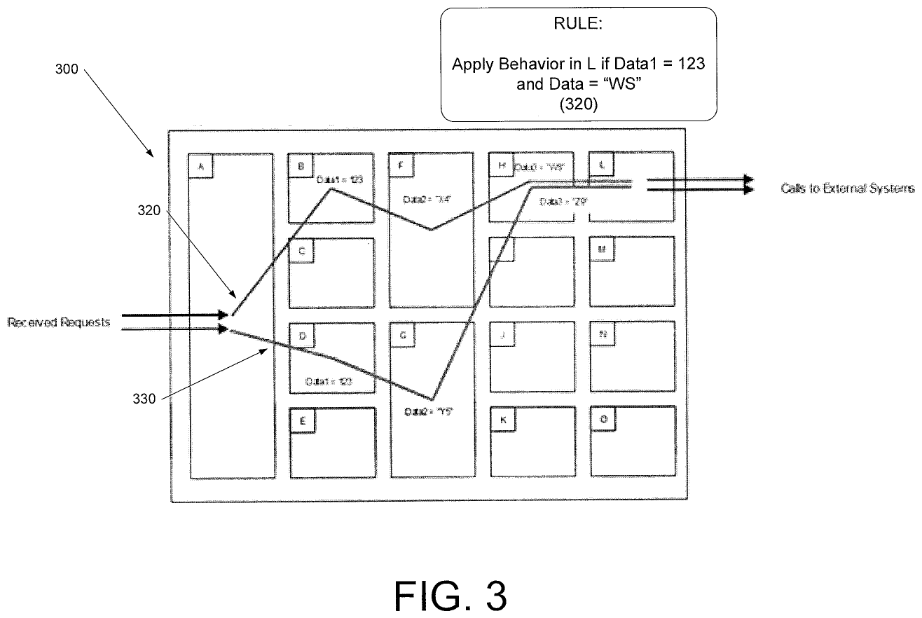

Referring to FIG. 3 an exemplary depiction of a rule being applied to application 300 consisting of logical subsections A-O based on runtime data is illustrated. In one embodiment, the rule, “apply behavior in L if Datal=123 and Data3=“WB,” is applied by the agent. Similar to FIG. 2, when the rule is met, such as by execution path 320, rule L is activated.

In one embodiment, the rule may be based on a combination of code execution path and runtime data.

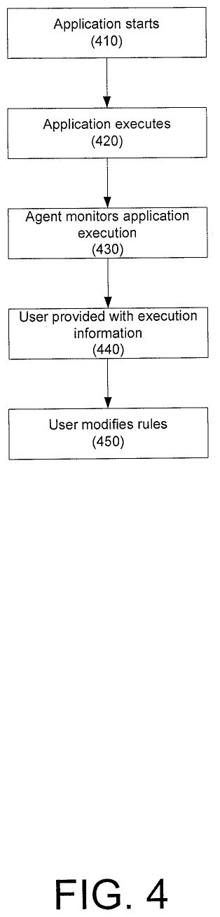

FIG. 4 depicts an exemplary method for building a rule for applying a behavior to simulate a fault/failure according to one embodiment. In step 410, an application that will be tested is initiated. In one embodiment, an agent may be deployed to the application by, for example, as part of the application's deployment file, by being associated with the application server, etc.

In one embodiment, the control server may load application behavior rules from, for example, the persistent data store, and may provide the application behavior rules to the agent. In one embodiment, the agent may enable or disable the application behavior rules based on the settings in the data store, selections from the user via a graphical user interface, etc.

In step 420, the application may execute.

In step 430, the agent may monitor the execution of the application. Application execution information may be sent from the agent to the control server, and may be saved to the persistent data store.

In one embodiment, the application may monitor the execution to see if any of the application behavior rules have been met.

In step 440, the user may be provided with application execution information. In one embodiment, the control server may load application execution information from the persistent data store and may provide to the user via, for example, a graphical user interface.

In another embodiment, the control server may request application execution information from the agent, and may provide to the user via, for example, the graphical user interface.

In step 450, the user may modify rules. For example, the user may create, add, delete, modify, etc. rules which may be stored to the persistent data store. In one embodiment, the rule changes may be provided to the agent.

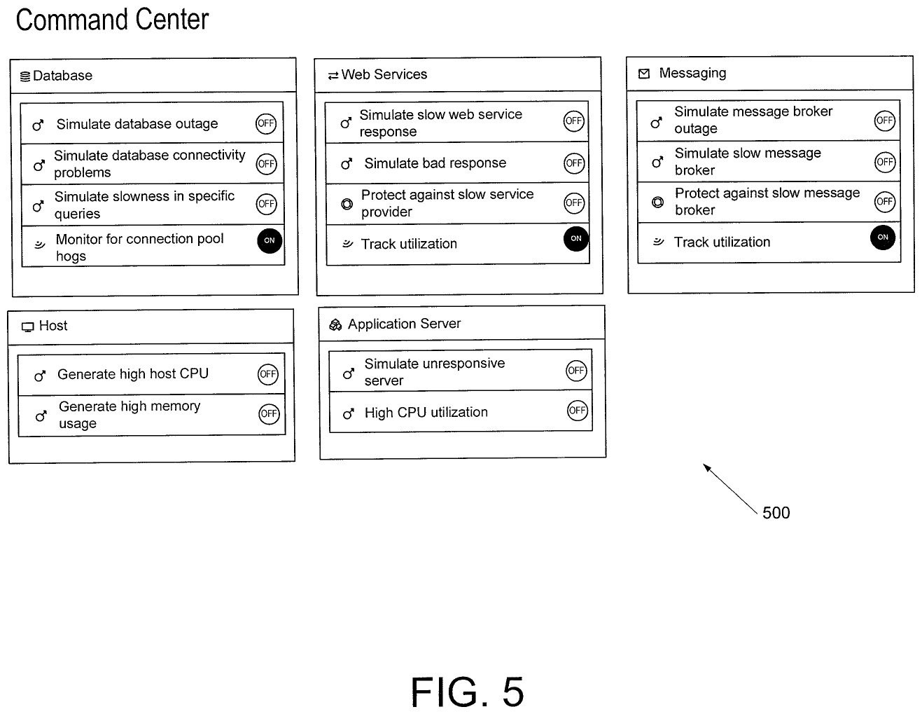

FIG. 5 depicts an exemplary graphical user interface according to one embodiment. It should be noted that this depiction is exemplary only and additional, different, greater, and/or fewer options may be provided. Interface 500 may depict different behaviors that may be associated with, for example, databases, web services, messaging, the host, and the application server. The behaviors are not restricted in purpose, and may simulate faults/failures, gather and make available runtime data, change runtime data and component configurations, or implement solutions to problems. In one embodiment, the behaviors to activate may be controlled by toggling a “button” on or off.

Other fault/failures and/or methods for selecting fault/failures to simulate may be used as is necessary and/or desired.

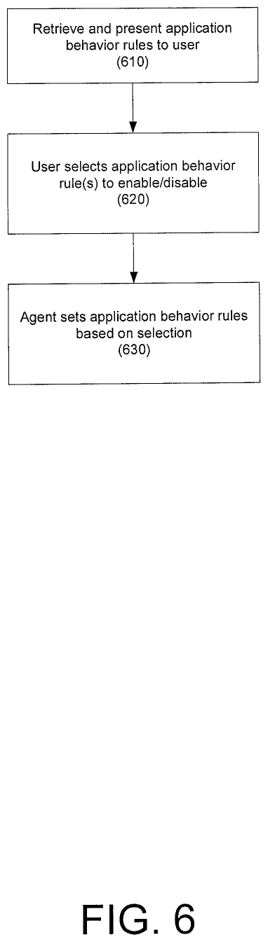

FIG. 6 depicts a resiliency test process according to one embodiment. In the embodiment depicted in this figure, the agent has already loaded the behavior rules and has activated the enabled rules on the application.

In step 610, the existing application behavior rules may be retrieved for the user and presented to the user. In one embodiment, the application behavior rules may be retrieved from the persistent data store, from the agent, etc. In one embodiment, the current status or the application behavior rules may be displayed to the user via a graphical user interface.

In step 620, the user may enable or disable one or more application behavior rule. In one embodiment, via the graphical user interface, the user may select the application behavior rules to enable or disable.

In step 630, the agent may set the application behavior rules to match the user's selection by enabling or disabling the application behavior rules. In one embodiment, the agent may change the execution profile of the running application to match the behavior rule state.

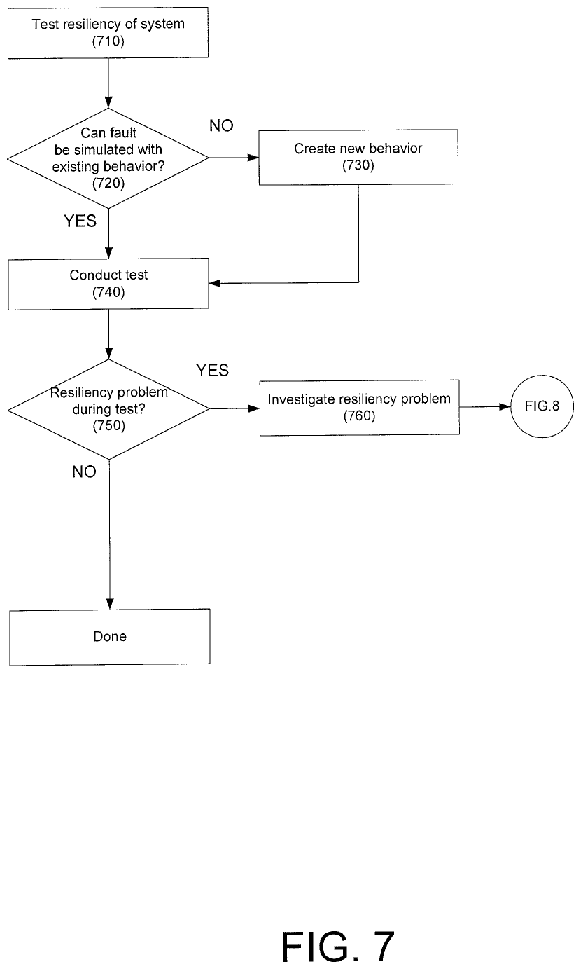

Referring to FIG. 7, a method of testing the resiliency of a system according to one embodiment is disclosed.

In step 710, the resiliency testing is initiated by, for example, associating an application with an agent, launching the control server interface, etc. In one embodiment, the fault/failure that is to be tested may be determined. Example faults/failures may include database faults/failures (e.g., database outage, database connectivity problems, slowness, etc.), web service faults/failures (e.g., slow web service response, bad response, etc.), messaging faults/failures (e.g., message broker outage, message broker slowness, etc.), host faults/failures (e.g., generate high host CPU usage, generate high host memory usage, etc.), and application faults/failures (unresponsive server, high CPU utilization, etc.), etc. Example services that may be selected may include database services (e.g., monitoring for connection pool hogs, etc.), web service services (e.g., tracking utilization, etc.), messaging services (e.g., tracking utilization, etc.), measuring durations of activities, etc.

In step 720, a determination as to whether the fault/failure can be simulated with an existing behavior is determined. In one embodiment, the user may select a fault/failure from a library of available faults/failures, an the system may identify the behavior to simulate that fault/failure. Other methodologies for identifying components may be used as necessary and/or desired.

In step 730, if the fault/failure cannot be simulated with an existing behavior, the user may create a behavior to simulate the fault/failure. This may be done, for example, by programming the behavior in the desired language.

If there is a component available to simulate the fault/failure, or one has been created, in step 740 the fault/failure may be simulated by the agent. In one embodiment, the agent may simulate the fault/failure after one or more application behavior rules are met. In another embodiment, the agent may simulate the fault/failure without an application behavior rule being met.

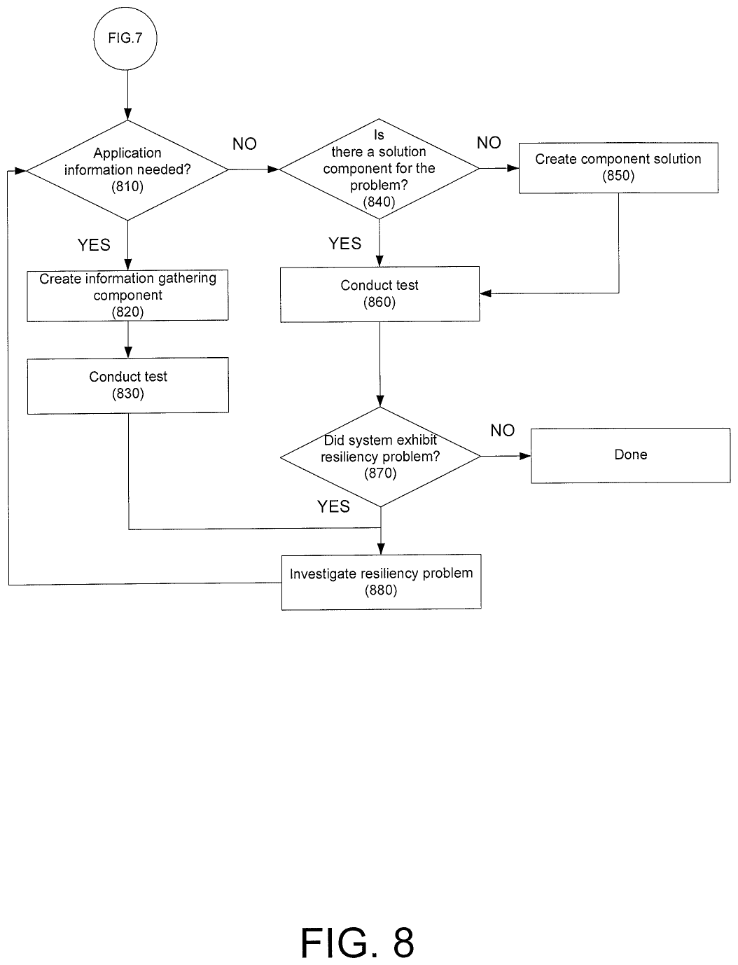

In step 750, a determination as to whether there was a resiliency problem during the test is made. For example, the user may be informed that the application did or did not meet functional or non-functional requirements or operational standards. In one embodiment, if there is are no resiliency problems, the test is complete. If there is a resiliency problem, in step 760, the resiliency problem is investigated. This is described in greater detail in FIG. 8.

Referring to FIG. 8, the process continues at step 810. In one embodiment, a determination as to whether any information from the application is needed to investigate the resiliency problem. For example, the agent may provide, for example, application resource metrics and runtime data.

In step 820, if additional data is needed to investigate the resiliency problem, an information gathering component may be selected or created. Example information that may be gathered may include thread counts per activity, activity duration, resources per transaction, etc. The information may be made available through a variety of mechanisms such as logs, monitoring tools, etc.

In step 830, the test may be conducted with the information gathering component. This may be similar to step 740. Using the information gathered by the information gathering component, in step 880, the resiliency problem may be investigated.

If, in step 810, assistance is not needed to investigate the resiliency problem, in step 840, a determination is made as to whether there is a component solution for the resiliency problem. Example component solutions may include, for example, gates/throttles limiting access to components that are not behaving appropriately, components that configure other components differently, components that make available additional application resource or more efficiently use existing application resources. If there is not, in step 850, a component solution may be created.

In step 860, using either the selected component solution from step 840, or the created component solution from step 850, the teste may be conducted. This may be similar to step 740.

In step 870, a determination is made whether the application with the component solution exhibited the resiliency problem. If it does not, the testing may be complete. If it does, the resiliency problem may be investigated in step 880. This may involve, for example, manual troubleshooting, investigation, selection of a different component solution, etc.

It should be recognized that although several embodiments have been disclosed, these embodiments are not exclusive and aspects of one embodiment may be applicable to other embodiments.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system, Virtualized hosts/OS, or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, Bluetooth, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1-8. (canceled)

9. A method for resiliency testing, comprising:
identifying a fault condition to simulate in a software application running on a computer processor, the software application including a plurality of logical subsections;
providing an application behavior rule, from a plurality of application behavior rules, that defines the fault condition and specifies a fault behavior for simulating the fault condition, wherein the fault condition corresponds to one of a presence of one or more first logical subsections in an execution path of the software application and one or more runtime data associated with the execution path of the software application and wherein the fault behavior is associated with an execution of a second logical subsection that is distinct from the one or more first logical subsections;
detecting, in the execution path of the software application, the fault condition as defined in the application behavior rule;
simulating the fault condition by applying the fault behavior specified by the, application behavior rule, wherein applying the fault behavior comprises the execution of the second logical subsection;
creating an information gathering component to collect execution data for the software application;
testing the modified software application by executing the modified software application;
collecting execution data using the information-gathering component;
identifying a resiliency problem based on the execution data; and
outputting the collected execution data.

10. The method of claim 9, wherein the fault condition is based on slowness.

11. The method of claim 9, wherein the fault condition is based on an outage.

12. The method of claim 9, wherein the fault condition is based on a hardware failure.

13. The method of claim 9, wherein the fault condition is based on a lack of responsiveness.

14. (canceled)

15. The method of claim 9, wherein the information gathering component comprises a second software application.

16. The method of claim 9, wherein the execution data comprises runtime data.

17. The method of claim 9, further comprising:
selecting a solution component for the resiliency problem;
executing the software with a fault-simulating component and the solution component; and
determining that the resiliency problem based on the fault-simulating component is not present.

18. (canceled)

19. The method of claim 9, wherein the fault behavior corresponds to a description provided by a user.

20. The method of claim 9, wherein the application behavior rule is selected from the plurality of application behavior rules provided by a control server.

21. The method of claim 9, wherein the fault behavior is provided by a control server.
